(19) United States
(12) Patent Application Publication
(10) Pub. No.: US 2016/0132614 A1
(43) Pub. Date: May 12, 2016

(54) CONTEXTUAL INDEXING IN A BUILDING AUTOMATION SYSTEM

(71) Applicant: TRANE INTERNATIONAL INC., Piscataway, NJ (US)

(72) Inventors: Benedict John Eiynk, North Branch, MN (US); Susan M. Mairs, St. Paul, MN (US); Mitchel James Anderson, Hugo, MN (US)

(21) Appl. No.: 14/939,423

(22) Filed: Nov. 12, 2015

Related U.S. Application Data
(60) Provisional application No. 62/078,599, filed on Nov. 12, 2014.
(60) Provisional application No. 62/078,548, filed on Nov. 12, 2014.

(51) Int. Cl. G06F 17/30; G05B 15/02; F24F 11/00

(52) U.S. Cl. CPC G06F 17/30991; F24F 11/0086; G05B 15/02

(57) ABSTRACT

Systems and methods for a context-based user interface in a building automation system are described. The method includes receiving, by the building automation system, a user request including context information. The method further includes determining a list of matching reports based on the context information; and providing the list of matching reports to the user interface.

### CROSS-REFERENCE TO RELATED APPLICATIONS

The present disclosure is related to co-owned U.S. provisional application No. 62/078,548, filed on Nov. 12, 2014 entitled “CONTEXTUAL SCORING IN A BUILDING AUTOMATION SYSTEM,” having named inventors Benedict Eiynk, Susan Mairs, and Mitchel Anderson, with Attorney Docket Number: 17742US01 (INGE-007 P), the entirety of which is incorporated herein by reference.

### FIELD

This disclosure relates generally to a building automation system. More specifically, the disclosure relates to providing a context-based user interface for a building automation system.

### BACKGROUND

A building automation system is a computerized network of electronic devices that can be configured to control one or more systems such as, but not limited to, mechanical, electrical, lighting, and security systems of a building. For example, a building automation system can be configured to control a heating, ventilation, and air conditioning (HVAC) system and its components for a building. A user, such as, but not limited to, a facility manager, a building maintenance engineer, or the like, typically interacts with the building automation system via one or more computers that are networked with a variety of equipment controllers and sensors. The user may also be able to interact with the building automation system via one or more mobile devices such as, but not limited to, a cellular phone, a tablet, or the like.

### SUMMARY

This disclosure relates generally to a building automation system. More specifically, the disclosure relates to providing a context-based user interface for a building automation system.

A building automation system can be configured to provide a user interface based on a context of a user.

In an embodiment, the building automation system can provide options to a user based on context information that indicates his/her context in the building automation system. In such an embodiment, the building automation system can provide the options based on matching the context information within a of options.

In an embodiment, the library of options includes a list of reports and context information associated with each of the listed reports.

In an embodiment, the context information associated with a report from the list of reports is system-defined. In an embodiment, the context information associated with a report from the list of reports is user-defined.

A computer-implemented method for providing context-based options to a user of a building automation system for a heating, ventilation, and air conditioning (HVAC) system is also disclosed. The method includes receiving, by the building automation system, a user request including context information. The method further includes determining a list of reports based on the context information; and providing the list of reports to a user interface.

A building automation system is also disclosed. The building automation system includes one or more user devices in communication with a server via a network. The server is configured to receive, by the building automation system, a user request including context information and determine a list of matching reports based on the context information. The server is further configured to provide the list of matching reports to the user interface.

A computer-implemented method for creating a context-based report in a building automation system for a heating, ventilation, and air conditioning (HVAC) system is also disclosed. The method includes receiving, by the building automation system, a user request to create a report; determining context information associated with the user request; receiving user-defined context information; and creating the report.

### BRIEF DESCRIPTION OF THE DRAWINGS

References are made to the accompanying drawings that form a part of this disclosure, and which illustrate embodiments in which the disclosed systems and methods can be practiced.

FIG. 1 is a schematic diagram of a system including a building automation system, according to an embodiment.

FIG. 2A illustrates a method to provide a user with options based on the user's context in a building automation system, according to an embodiment.

FIG. 2B illustrates a method to add a report having context information in a building automation system, according to an embodiment.

FIGS. 3A-3D illustrate user interfaces for the building automation system as described herein, according to an embodiment.

FIG. 4 is a schematic diagram of an architecture for a computer device, according to an embodiment.

Like reference numbers represent like parts throughout.

### DETAILED DESCRIPTION

This disclosure relates generally to a building automation system. More specifically, the disclosure relates to providing a context-based user interface for a building automation system.

“Context,” as used herein, refers generally to a context within a heating, ventilation, and air conditioning (HVAC) system. The context can be based on, for example, equipment or a subsystem (e.g., a chiller plant or the like) within the HVAC system, the user's location within the system, a building within the system, or the like.

“Context information,” as used herein, refers generally to any attributes, metadata, or tags that can be passed by the system in order to indicate the context. Examples of context information include, but are not limited to, a page from which a user makes a user request, a user identifier (e.g., a username, a user privilege group, or the like), a type of action requested (e.g., run a report, or the like), a location of the user (e.g., in which building and/or room of the building the user is located), a particular piece of HVAC equipment which the user is viewing within the building automation system, details of issues regarding operation of HVAC equipment, or the like.

“System-defined context information,” as used herein, refers generally to context information that is supplied by a building automation system. An example of system-defined context information includes, but is not limited to, associating a building name with a report for a particular building (e.g., a user creates a report for building 1, system-defined context information can be, for example, “building 1”).

“User-defined context information,” as used herein, refers generally to context information that is supplied by a user of the building automation system. An example of user-defined context information includes, but is not limited to, a user associating a building nickname with a report for a particular building (e.g., a user creates a report for building 1, user-defined context information can be, for example, “main building”).

A “system-defined report,” as used herein, can include a report that is defined by the building automation system. A system-defined report can, for example, be defined by the building automation system such that a user can select and run the report without configuring any report definitions.

A “user-defined report,” as used herein, can include a report that is defined by a user of the building automation system. A user-defined report may alternatively be referred to as a custom report.

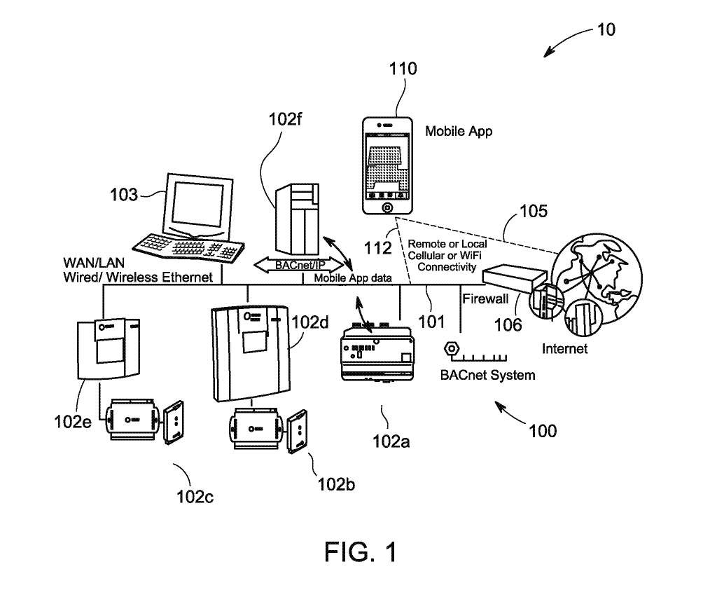

FIG. 1 is a schematic diagram of a system 10 including a building automation system 100, according to an embodiment. The building automation system 100 includes a computer 103 specialized to carry out the methods described herein. The computer 103 is connected to a network 101. The computer 103 can be hardwired to the network 101 in an embodiment or wirelessly connected to the network 101 in another embodiment. The network 101 uses a communication standard or protocol to link various subsystems throughout the building automation system 100. For example, the network 101 links a system control unit 102a, a unit control device 102b, 102c, and/or other devices 102d, 102e, 102f, and can provide a system-wide user access and control from the computer 103.

The computer 103 can represent a variety of electronic devices. For example, the computer 103 can have a display device and be a desktop computer, a laptop computer, a tablet, a cellular phone, a personal digital assistant, or other similar electronic device.

The building automation system 100 is connected in communication with the Internet 105 and includes a network security device 106. It is to be appreciated that the network security device 106 is not required in an embodiment. The network security device 106 can be, for example, a firewall that secures and protects the building automation system 100 from unwanted intrusion via the Internet 105.

The illustrated embodiment includes a mobile device 110 connected to the building automation system 100 via, for example, the Internet 105 through the network security device 106. The mobile device 110 can alternatively be referred to as a user device. The mobile device 110 is not part of the building automation system 100. The mobile device 110 can connect to the building automation system 100 via a local wireless connection 112. The local wireless connection 112 can be established behind the network security device 106 so that the mobile device 110 can connect to one or more of the components or devices 102a 102f of the building automation system 100 without requiring communication between the mobile device 110 and the building automation system 100 to go through the network security device 106. This can, for example, increase the speed of the communication between the mobile device 106 and the building automation system 100.

The mobile device 110 can connect to the building automation system 100 via the Internet 105 using, for example, cellular, 3G, 4G, or other wireless communication protocols. The mobile device 110 can connect to the building automation system 100 via the local wireless connection 112 using, for example, WiFi, Bluetooth, or other wireless communication protocols. The mobile device 110 can connect to the building automation system 100 using, for example, a combination of the Internet 105 and the local wireless connection 112.

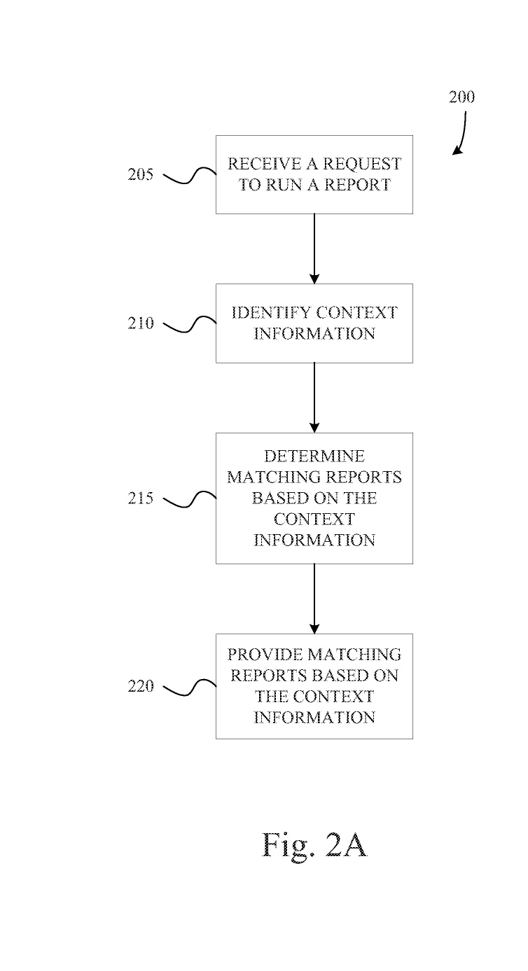

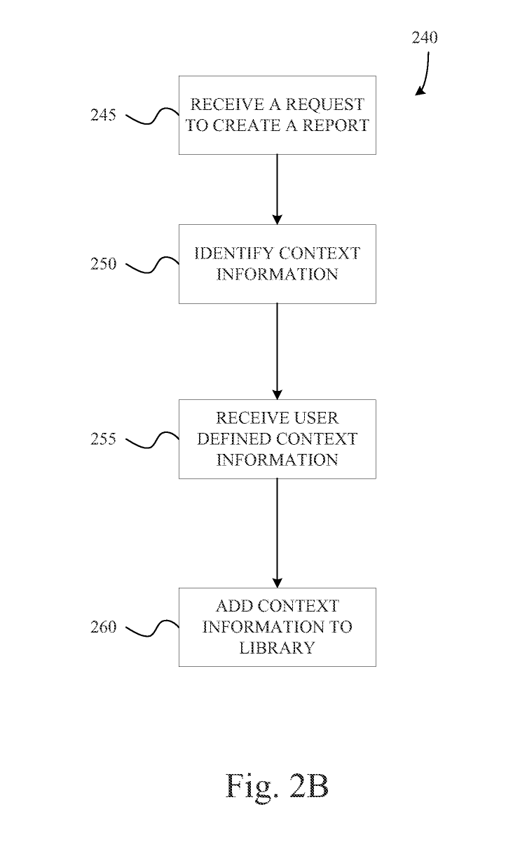

FIG. 2A illustrates a method to provide a user with options based on the user's context in a building automation system (e.g., the building automation system 100 of FIG. 1), according to an embodiment.

The method 200 begins at 205 when the building automation system 100 receives a user request to run a report. The user request can include context information related to, for example, the action the user took to generate the user request. For example, the user request can include information such as, but not limited to, a page from which the user made the user request, a user identifier (e.g., username, a user privilege group, or the like), a type of action requested, a location of the user (e.g., in which building and/or room of the building the user is located), a particular piece of HVAC equipment which the user is viewing within the building automation system, details of issues regarding operation of HVAC equipment, or the like. At 210, the building automation system 100 identifies the context information from the user request.

At 215, the building automation system 100 determines one or more matching reports based on the context information identified at 210. At 215 the building automation system 100 generally may access a library or database containing context information and associations. For example, the library can include information such as a report name and one or more pieces of context information associated with the particular report. In an embodiment, the library includes a report identified as Report A. It is to be appreciated that Report A can be a system-defined report provided to a user, or alternatively, a user-defined report that the user has previously created. Report A can have a list including context information such as, but not limited to, a building identifier (e.g., Building 1, Building A, or the like), a report type identifier (e.g., Weekly Performance, Monthly Performance, or the like), an identifier associated with a particular piece of equipment, or other similar context information. Thus, at 215, if the context information in the user request indicates that the user is in Building 1, the building automation system 100 may determine one or more matching reports having context information identifying the report as associated with Building 1.

At 220, the building automation system 100 provides a list of matching reports to the user based on the context information of the user request. It is to be appreciated that the list of matching reports can include one or more matching reports. In an embodiment, the building automation system may not identify any matching reports and can accordingly display an indication that no such reports are in the system and provide the user with an option to create a new report.

FIG. 213 illustrates a method 240 to add a report having context information in a building automation system (e.g., the building automation system 100 of FIG. 1), according to an embodiment.

The method 240 begins at 245 when the building automation system receives a user request to create a report. The user can include context information related to, for example, the action the user took to generate the user request. For example, the user request can include information such as, but not limited to, a page from which the user made the user request, a user identifier (e.g., a username, a user privilege group, or the like), a type of action requested, a location of the user (e.g., in which building and/or room of the building the user is located), a particular piece of HVAC equipment which the user is viewing within the building automation system, or the like. At 250, the building automation system 100 identifies the context information from the user request. At 255, the building automation system 100 also receives user-defined context information. It is to be appreciated that if the user chooses not to add context information from the report that the context information at 255 can, for example, be blank.

At 260, the context information is added to a library. The context information can be added along with a report title. Accordingly, a new entry in the library can include the newly created report along with the context information that was determined in the method 240.

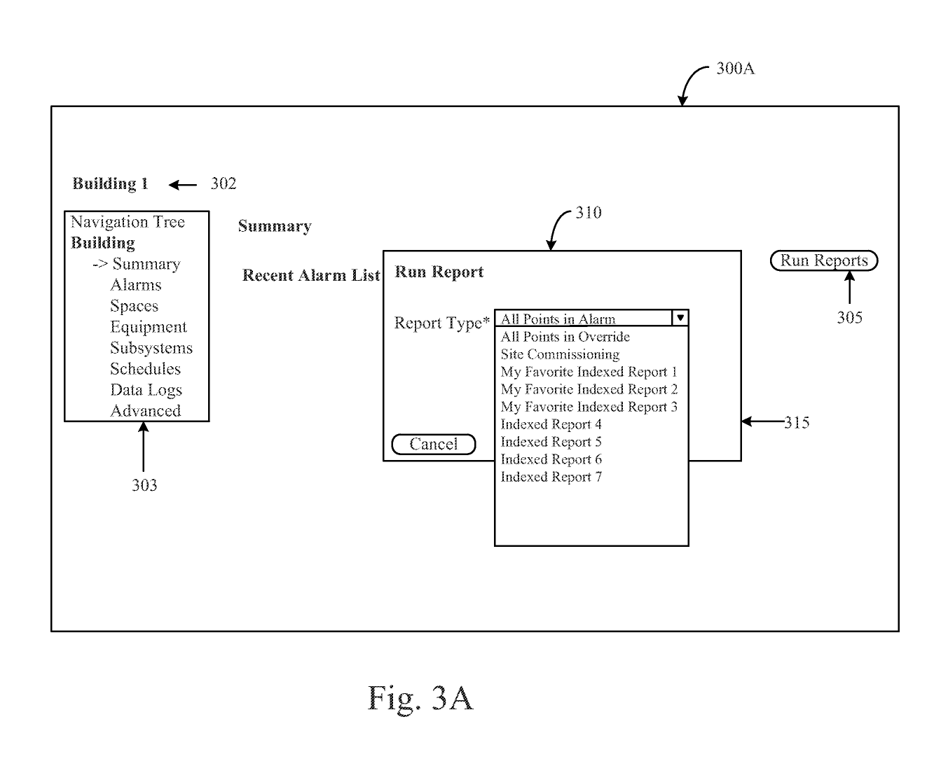

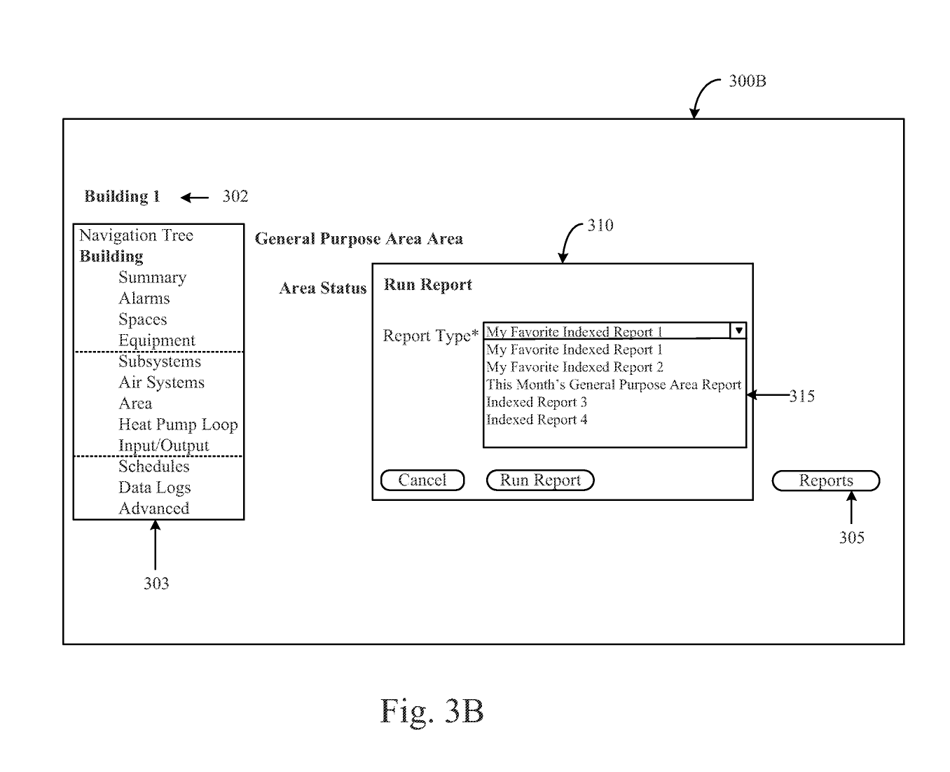

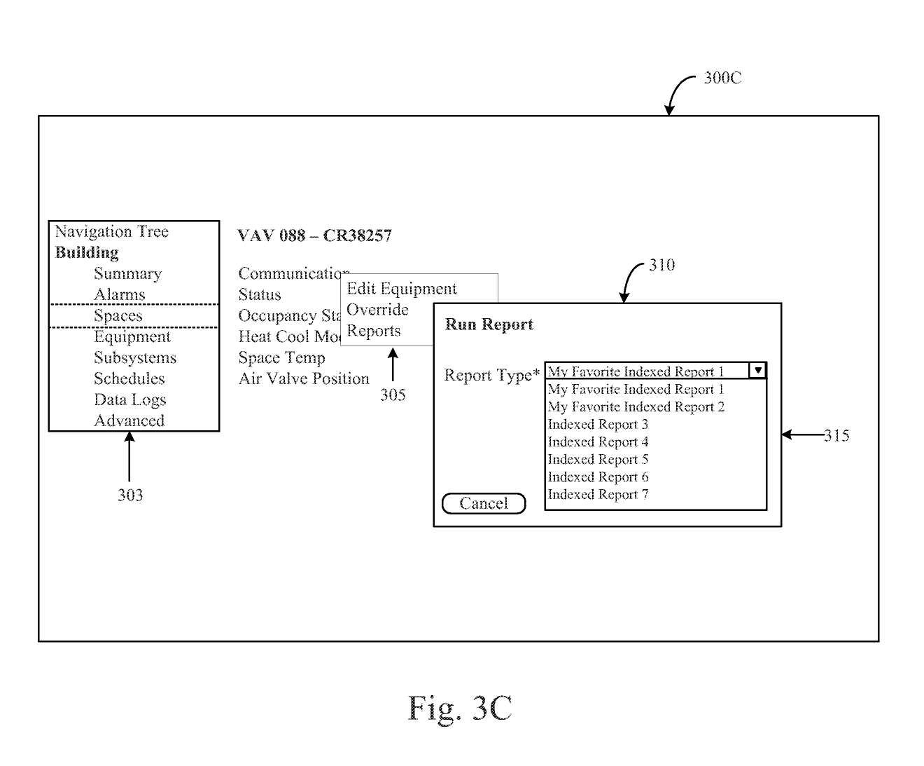

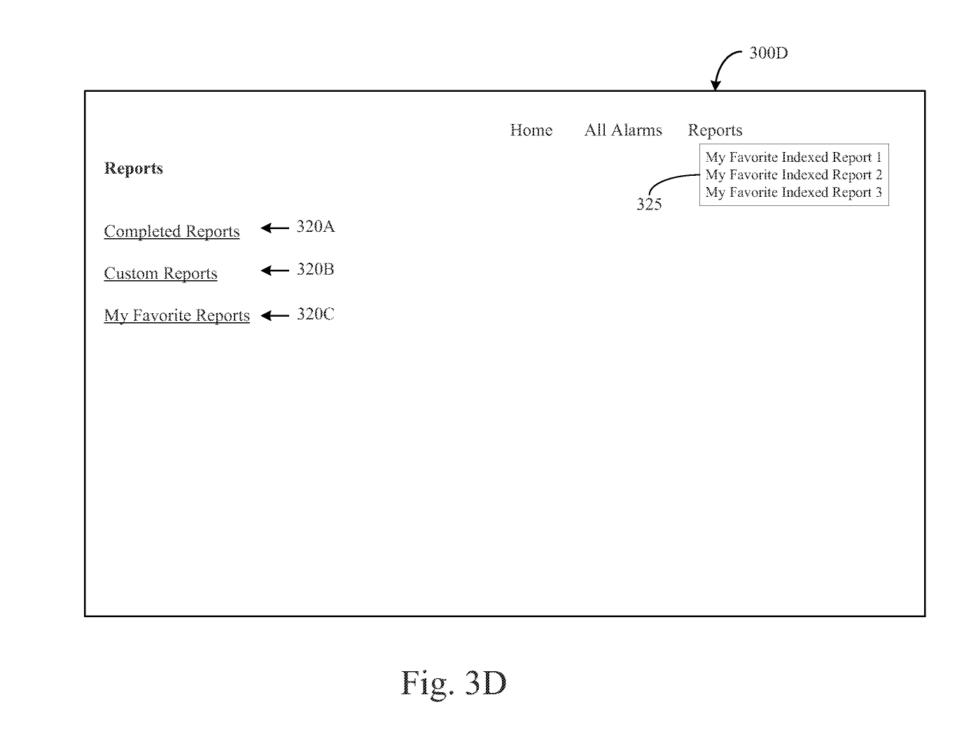

FIG. 3A illustrates a user interface 300A for the building automation system 100 (FIG. 1), according to an embodiment. The user interface 300A generally represents a context based on a building within the system (e.g., “Building 1”). The user interface 300A also represents a context based on a user (e.g., the user's username, associated privileges, or the like). The user interface 300A is generally representative of a summary page for Building 1 within a particular system. It is to be appreciated that all text and images on the user interface 300A are exemplary arid are not intended to be limiting.

The user interface 300A includes a page label 302, and a navigation tree 303. The page label for the user interface 300A indicates that the user is currently viewing details relating to an HVAC system for “Building 1.” The navigation tree 303 indicates that the user is further viewing a “Summary” of details relating to the HVAC system for “Building 1.” A user can select a report button 305, which displays a report interface 310, and a report selector 315. In the illustrated example of FIG. 3A, the report selector 315 is a dropdown list. The report selector includes reports for the user that can be system-defined (e.g., All Points in Alarm, All Points in Override, Site Commissioning, or the like) as well as reports based on the context of the building (e.g., Indexed Reports 4-7 which can be system-defined reports, user-defined reports, or combinations thereof). The report selector further includes reports based on the user's context (e.g., My Favorite Indexed Reports 1-3 which can be system-defined reports, user-defined reports, or combinations thereof).

FIG. 3B illustrates a user interface 300B for the building automation system 100 (FIG. 1), according to an embodiment. The user interface 300B generally represents a context based on a location within the system (e.g., “General Purpose Area Area”). The user interface 300B also represents a context based on a user (e.g., the user's username, associated privileges, or the like). The user interface 300B is generally representative of a particular location within “Building 1.” In the illustrated embodiment, the location is the “General Purpose Area Area.” In an embodiment, a similar user interface could be shown for a particular piece of equipment (e.g., a particular variable air volume (VAV) box, a particular heat pump, or the like). Aspects of FIG. 3B can be the same as or similar to aspects of FIG. 3A. In FIG. 3B, the report selector 315 again includes options for the user that can be based on the context of the building (e.g., Indexed Reports 3-4 which can be system-defined reports, user-defined reports, or combinations thereof) and/or based on the user's context (e.g., My Favorite Indexed Reports 1-2 which can be system-defined reports, user-defined reports, or combinations thereof). Further, a report associated with the area “General Purpose Area” is included in the report selector 315 as “This Month's General Purpose Area Report.”

FIG. 3C illustrates a user interface 300C for the building automation system 100 (FIG. 1), according to an embodiment. The user interface 300C generally represents a context based on a particular piece of equipment within the system (e.g., “VAV 088-CR38257”). The user interlace 300B also represents a context based on a user (e.g., the user's username, associated privileges, or the like). In the illustrated embodiment, the report button 305 is illustrated as one of the options in a list that includes “Edit Equipment,” “Override,” and “Reports.” Selection of the “Reports” option similarly displays reports associated with this particular piece of equipment (e.g., Indexed Reports 4-7 which can be system-defined reports, user-defined reports, or combinations thereof) and reports based on the user's context (e.g., My Favorite Indexed Reports 1-3 which can be system-defined reports, user-defined reports, or combinations thereof).

FIG. 3D illustrates a user interface 300D for the building automation system 100 (FIG. 1), according to an embodiment. The user interface 300D generally represents a report management user interface. The user interface 300D includes report management options 320A-320C. The report management option 320A enables a user to view, email, and/or print reports that were previously generated and/or created. The completed reports can include all reports for a particular system and may not be specific to the user. In an embodiment, the completed reports can be limited based on a role and/or privilege group assigned to the particular user. For example, users can be provided with different levels of access to reports in the system. The report management option 320B can be selected in order for the user to design, modify, delete, and/or email reports. The report management option 320C can be selected in order for the user to design, modify, delete, and/or email custom reports that the user has selected as a favorite report. In an embodiment, a favorite report can, for example, include a report that a user runs on a regular basis. In addition to the report management options 320A-320C, a reports menu option 325 can be used to select a favorite report.

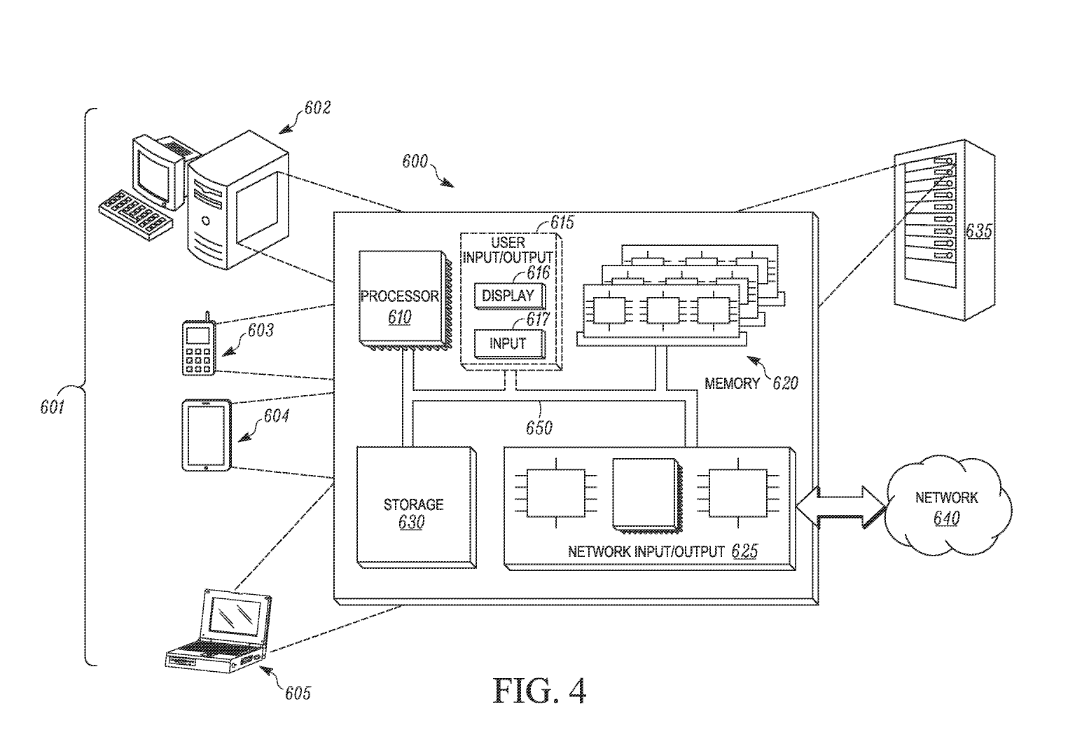

FIG. 4 is a schematic diagram of an architecture for a computer device, according to an embodiment. The computer device 600 and any of the individual components thereof can be used for any of the operations described in accordance with any of the computer-implemented methods described herein.

The computer device 600 generally includes a processor 610, memory 620, a network input/output (I/O) 625, storage 630, and an interconnect 650. The computer device 600 can optionally include a user I/O 615, according to an embodiment. The computer device 600 can be in communication with one or more additional computer devices 600 through a network 640.

The computer device 600 is generally representative of hardware aspects of a variety of user devices 601 and a server device 635. The illustrated user devices 601 are examples and are not intended to be limiting. Examples of the user devices 601 include, but are not limited to, a desktop computer 602, a cellular/mobile phone 603, a tablet device 604, and a laptop computer 605. It is to be appreciated that the user devices 601 can include other devices such as, but not limited to, a personal digital assistant (PDA), a video game console, a television, or the like. In an embodiment, the user devices 601 can alternatively be referred to as client devices 601. In such embodiments, the client devices 601 can be in communication with the server device 635 through the network 640. One or more of the client devices 601 can be in communication with another of the client devices 601 through the network 640 in an embodiment.

The processor 610 can retrieve and execute programming instructions stored in the memory 620 and/or the storage 630. The processor 610 can also store and retrieve application data residing in the memory 620. The interconnect 650 is used to transmit programming instructions and/or application data between the processor 610, the user I/O 615, the memory 620, the storage 630, and the network I/O 640. The interconnect 650 can, for example, be one or more busses or the like. The processor 610 can be a single processor, multiple processors, or a single processor having multiple processing cores. In an embodiment, the processor 610 can be a single-threaded processor. In an embodiment, the processor 610 can be a multi-threaded processor.

The user I/O 615 can include a display 616 and/or an input 617, according to an embodiment. It is to be appreciated that the user I/O 615 can be one or more devices connected in communication with the computer device 600 that are physically separate from the computer device 600. For example, the display 616 and input 617 for the desktop computer 602 can be connected in communication but be physically separate from the computer device 600. In an embodiment, the display 616 and input 617 can be physically included with the computer device 600 for the desktop computer 602. In an embodiment, the user I/O 615 can physically be part of the user device 601. For example, the cellular/mobile phone 603, the tablet device 604, and the laptop 605 include the display 616 and input 617 that are part of the computer device 600. The server device 635 generally may not include the user I/O 615. In an embodiment, the server device 635 can be connected to the display 616 and input 617.

The display 616 can include any of a variety of display devices suitable for displaying information to the user. Examples of devices suitable for the display 616 include, but are not limited to, a cathode ray tube (CRT) monitor, a liquid crystal display (LCD) monitor, alight emitting diode (LED) monitor, or the like.

The input 617 can include any of a variety of input devices or means suitable for receiving an input from the user. Examples of devices suitable for the input 617 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 617 can be included for the user devices 601. In an embodiment the input 617 can be integrated with the display 616 such that both input and output are performed by the display 616.

The memory 620 is generally included to be representative of a random access memory such as, but not limited to, Static Random Access Memory (SRAM), Dynamic Random Access Memory (DRAM), or Flash. In an embodiment, the memory 620 can be a volatile memory. In an embodiment, the memory 620 can be a non-volatile memory. In an embodiment, at least a portion of the memory can be virtual memory.

The storage 630 is generally included to be representative of a non-volatile memory such as, hut not limited to, a hard disk drive, a solid state device, removable memory cards, optical storage, flash memory devices, network attached storage (NAS), or connections to storage area network (SAN) devices, or other similar devices that may store non-volatile data. In an embodiment, the storage 630 is a computer readable medium. In an embodiment, the storage 630 can include storage that is external to the computer device 600, such as in a cloud.

The network I/O 625 is configured transmit data via a network 640. The network 640 may alternatively be referred to as the communications network 640. Examples of the network 640 include, but are not limited to, a local area network (LAN), a wide area network (WAN), the Internet, or the like. In an embodiment, the network I/O 625 can transmit data via the network 640 through a wireless connection using WiFi, Bluetooth, or other similar wireless communication protocols. In an embodiment, the computer device 600 can transmit data via the network 640 through a cellular, 3G, 4G, or other wireless protocol. In an embodiment, the network I/O 625 can transmit data via a wire line, an optical fiber cable, or the like. It is to be appreciated that the network I/O 625 can communicate through the network 640 through suitable combinations of the preceding wired and wireless communication methods.

The server device 635 is generally representative of a computer device 600 that can, for example, respond to requests received via the network 640 to provide, for example, data for rendering a website on the user devices 601. The server 635 can be representative of a data server, an application server, an Internet server, or the like.

Aspects described herein can be embodied as a system, method, or computer readable medium. In an embodiment, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

An embodiment can be provided to an end-user through a cloud-computing infrastructure. Cloud computing generally includes the provision of scalable computing resources as a service over a network (e.g., the Internet or the like).

### Aspects:

It is noted that any of aspects 1-6 below can be combined with any of aspects 7-8.

Aspect 1. A computer-implemented method for providing context-based options to a user of a building automation system for a heating, ventilation, and air conditioning (HVAC) system, the method comprising:
receiving, by the building automation system, a user request including context information;
determining a list of reports based on the context information; and
providing the list of reports to the user interface.

Aspect 2. The method according to aspect 1, further comprising:
receiving a selection from the list of matching reports; and
providing the selected report to the user interface.

Aspect 3. The method according to any of aspects 1-2, wherein the context information is stored in a library and/or an index.

Aspect 4. The method according to any of aspects 1-3, wherein the context information is one of system-defined and user-defined.

Aspect 5. The method according to any of aspects 1-4, wherein the context information includes one or more of:
a piece of equipment in the HVAC system, a subsystem, a user's location within the building automation system, and a building within the HVAC system.

Aspect 6. The method according to any of aspects 1-5, wherein determining t e list of matching reports based on the context information includes matching the context information from the user request with a report identifier,

Aspect 7, A building automation system, comprising:
one or more user devices in communication with a server via a network, wherein the server is configured to:
   receive, by the building automation system, a user request including context information;
   determine a list of matching reports based on the context information; and
   provide the list of matching reports to the user interface.

Aspect 8. The building automation system according to aspect 7, wherein the server is further configured to:
receive a selection from the list of matching reports; and
provide the selected report to the user interface.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

The flowcharts described in this specification set forth the operations in an order which is indicative of an embodiment of the present disclosure. It is noted that in an embodiment, the order of the operations can vary. Further, one or more of the operations can be combined, or alternatively, separated into multiple operations. Other similar operations and the order of the operations may be equivalent in function, logic, or effect, without departing from the basic scope of the operations described.

With regard to the preceding description, it is to be understood that changes may be made in detail, especially in matters of the construction materials employed and the shape, size, and arrangement of parts without departing from the scope of the present disclosure. The word “embodiment” as used within this specification may, but does not necessarily, refer to the same embodiment. This specification and the embodiments described are exemplary only. Other and further embodiments may be devised without departing from the basic scope thereof, with the true scope and spirit of the disclosure being indicated by the claims that follow.

What is claimed is:

1. A computer-implemented method for providing context-based options to a user of a building automation system for a heating, ventilation, and air conditioning (HVAC) system, the method comprising:
receiving, by the building automation system, a user request including context information;
determining a list of reports based on the context information; and
providing the list of reports to the user interface.

2. The method according to claim 1, further comprising:
receiving a selection from the list of matching reports; and
providing the selected report to the user interface.

3. The method according to claim 1, wherein the context information is stored in a library and/or an index.

4. The method according to claim 1, wherein the context information is one of system-defined and user-defined.

5. The method according to claim 1, wherein the context information includes one or more of:
a piece of equipment in the HVAC system, a subsystem, a user's location within the building automation system, and a building within the HVAC system.

6. The method according to claim 1, wherein determining the list of matching reports based on the context information includes matching the context information from the user request with a report identifier.

7. A building automation system, comprising:
one or more user devices in communication with a server via a network, wherein the server:
receives, by the building automation system, a user request including context information;
determines a list of matching reports based on the context information; and
provides the list of matching reports to the user interface.

8. The building automation system according to claim 7, wherein the server:
receives a selection from the list of matching reports; and
provides the selected report to the user interface.

9. The building automation system according to claim 7, wherein the context information is stored in a library and/or an index.

10. The building automation system according to claim 7, wherein the context information is one of system-defined and user-defined.

11. The building automation system according to claim 7, wherein the context information includes one or more of:
a piece of equipment in the HVAC system, a subsystem, a user's location within the building automation system, and a building within the HVAC system.

12. The building automation system according to claim 7, wherein the server determines the list of matching reports based on the context information by matching the context information from the user request with a report identifier.

13. A computer-implemented method for creating a context-based report in a building automation system for a heating, ventilation, and air conditioning (HVAC) system, the method comprising:
receiving, by the building automation system, a user request to create a report;
determining context information associated with the user request;
receiving user-defined context information; and
creating the report.

14. The computer-implemented method according to claim 13, wherein the user-defined context information is stored in a context information library and/or an index.

15. The computer-implemented method according to claim 13, wherein the context information associated with the user request is system-defined context information.

16. The computer-implemented method according to claim 13, wherein the context information includes one or more of:
a piece of equipment in the HVAC system, a subsystem, a user's location within the building automation system, and a building within the HVAC system.
